(19) United States
(12) Patent Application Publication
(10) Pub. No.: US 2014/0331973 A1
(43) Pub. Date: Nov. 13, 2014

(54) INTERNAL COMBUSTION ENGINE

(71) Applicants: Kazuhisa Matsuda, Susono-shi (JP); Makoto Tomimatsu, Susono-shi (JP)

(72) Inventors: Kazuhisa Matsuda, Susono-shi (JP); Makoto Tomimatsu, Susono-shi (JP)

(73) Assignee: TOYOTA JIDOSHA KABUSHIKI KAISHA, Toyota-shi Aichi-ken (JP)

(21) Appl. No.: 14/276,174

(22) Filed: May 13, 2014

(30) Foreign Application Priority Data
May 13, 2013 (JP) 2013-100862

(51) Int. Cl. F02D 41/30

(52) U.S. Cl. CPC F02D 41/3094
USPC 123/478

(57) ABSTRACT

An internal combustion engine includes first and second fuel injection valves, a valve actuating device and an ECU. The ECU sets a distribution ratio of the first fuel injection valve to 100% when an accumulation amount Spfi is larger than a predetermined value Xpfi in a predetermined case. The predetermined case is a case where the valve actuating device closes the exhaust valve on an advance side with respect to an exhaust top dead center and a state where a minus overlap is formed between the intake valve and the exhaust valve is established and a case where the distribution ratio of the second fuel injection valve is set to 100%.

### INCORPORATION BY REFERENCE

The disclosure of Japanese Patent Application No. 2013-100862 filed on May 13, 2013 including the specification, drawings and abstract is incorporated herein by reference in its entirety.

### BACKGROUND OF THE INVENTION

1. Field of the Invention

The invention relates to an internal combustion engine.

2. Description of Related Art

There is known an internal combustion engine including a first injection unit that injects fuel into an intake passage communicating with a combustion chamber, a second injection unit that injects fuel into the combustion chamber, and a valve actuating device (for example, see Japanese Patent Application Publication No. 2012-229656 (JP 2012-229656 A)). JP 2012-229656 A describes an internal combustion engine specifically including a valve timing changing mechanism that changes the open and close timings of an intake valve as the valve actuating device. Japanese Patent Application Publication No. 2007-192088 (JP 2007-192088 A), Japanese Patent Application Publication No. 2005-220887 (JP 2005-220887 A), Japanese Patent Application Publication No. 2005-201083 (JP 2005-201083 A), Japanese Patent Application Publication No. 2005-113745 (JP 2005-113745 A) and PCT Application Publication No. 2011/148462 describe an internal combustion engine including first and second injection units.

Japanese Patent Application Publication No. 2007-186998 (JP 2007-186998 A) describes a technique for advancing intake valve close timing to a position at which blow-back of air-fuel mixture to a portion near a gas flow control valve is small. Japanese Patent Application Publication No. 2009-36117 (JP 2009-36117 A) describes a technique for starting enriching control when the output of a catalyst downstream-side O₂ sensor indicates a lean air-fuel ratio at the time of a return from fuel cut.

An internal combustion engine including first and second injection units is allowed to include the following valve actuating device as a valve actuating device. That is, the internal combustion engine is allowed to include a valve actuating device that changes at least the close timing of an exhaust valve among the valve characteristics of an intake valve and the exhaust valve that are arranged in association with the same combustion chamber. The valve characteristic is open timing, close timing, a lift amount, or a combination of them (such as a combination of the open timing and the close timing, a combination of the close timing and the lift amount, and a combination of the open timing, the close timing and the lift amount). The thus configured internal combustion engine is able to set a minus overlap as will be described below,

FIG. 11A and FIG. 11B are views that illustrate a minus overlap. FIG. 11A shows a first example of the open and close timings of each of an intake valve 54 and an exhaust valve 55. FIG. 11B shows a second example of the open and close timings of each of the intake valve 54 and the exhaust valve 55. A minus overlap is an overlap in valve-closed period between the intake valve 54 and the exhaust valve 55, and is specifically an overlap in valve-closed period, formed in a period from the close timing of the exhaust valve 55 to the open timing of the intake valve 54.

Here, the open and close timings of each of the intake valve 54 and the exhaust valve 55 are generally allowed to be set as shown in FIG. 11A. That is, the open and close timings are allowed to be set such that the close timing of the exhaust valve 55 and the open timing of the intake valve 54 are located at the exhaust top dead center of a piston. On the other hand, in the above-described internal combustion engine, the open and close timings of each of the intake valve 54 and the exhaust valve 55 are also allowed to be set as shown in FIG. 11B.

That is, the open and close timings are also allowed to be set such that the exhaust valve 55 closes on the advance side with respect to the exhaust top dead center and a minus overlap is formed between the intake valve 54 and the exhaust valve 55. In this case, high-temperature and high-pressure gas in the combustion chamber is re-compressed toward the exhaust top dead center as the exhaust valve 55 closes. Therefore, in this case, when the intake valve 54 opens, gas is blown back from the combustion chamber to the intake passage. Such blow-back of gas can be, for example, utilized as will be described below.

FIG. 12 is a view that illustrates a state of adhesion of injected fuel. An internal combustion engine 50X includes the intake valve 54, the exhaust valve 55, first and second fuel injection valves 56, 57 and a valve actuating device 60. The first fuel injection valve 56 corresponds to the first injection unit. The second fuel injection valve 57 corresponds to the second injection unit. In the internal combustion engine 50X, fuel injected from the first fuel injection valve 56 adheres to the intake valve 54 and an intake passage wall. In contrast, in the internal combustion engine 50X, vaporization of adhered fuel is facilitated by generating blow-back of gas as described above. As a result, it is possible to improve exhaust emission through a reduction in unburned fuel. On the other hand, blow-back of gas leads to production of a deposit as will be described below.

FIG. 13 is a view that illustrates production of a deposit. When gas is blown back, fuel remaining in an injection hole of the first fuel injection valve 56 is oxidized by heat and oxidizing agent (for example, NOx, SOx or O₂) contained in the blown-back gas. As a result, a binder is produced in the injection hole of the first fuel injection valve 56. As a result of adhesion of PM, such as HC, to the produced binder and growth of the PM, a deposit is produced in the injection hole of the first fuel injection valve 56. However, the deposit is allowed to be washed by injected fuel.

Incidentally, in the internal combustion engine 50X, a required fuel injection amount may become smaller than a predetermined injection amount (a minimum injection amount required by the second fuel injection valve 57 in order to prevent adhesion of a deposit to the injection hole of the second fuel injection valve 57). Such a case occurs during high-temperature low-load state including, for example, during a high-temperature idle state. In such a case, the internal combustion engine 50X is able to determine a fuel distribution ratio between the fuel injection valves 56, 57. That is, the distribution ratio is allowed to be determined such that fuel is injected from the second fuel injection valve 57 of both the fuel injection valves 56, 57. In this case, it is possible to make it difficult for a deposit to adhere to the injection hole of the second fuel injection valve 57.

Incidentally, in this case, fuel is not injected from the first fuel injection valve 56. Therefore, when the case where the distribution ratio is determined as described above is also the case where the exhaust valve 55 closes on the advance side with respect to the exhaust top dead center and a minus overlap is formed, a deposit may accumulate in the injection hole of the first fuel injection valve 56 due to blow-back of gas. As a result, the injection hole of the first fuel injection valve 56 is clogged by the deposit, which may lead to deterioration in exhaust emission or a decrease in internal combustion engine performance.

### SUMMARY OF THE INVENTION

The invention provides an internal combustion engine that is able to prevent or suppress accumulation of a deposit in an injection hole of an injection unit, which injects fuel into an intake passage, due to blow-hack of gas in a predetermined case.

A first aspect of the invention provides an internal combustion engine. The internal combustion engine includes: an intake valve and an exhaust valve arranged in association with a combustion chamber; a piston located to define the combustion chamber; a first injection unit configured to inject fuel into an intake passage that communicates with the combustion chamber; a second injection unit configured to inject fuel into the combustion chamber; a valve actuating device configured to change at least close timing of the exhaust valve in valve characteristics of the intake valve and exhaust valve; and a controller including a setting unit and an estimation unit, the setting unit being configured to set a distribution ratio of fuel between the first and second injection units, the estimation unit being configured to estimate an accumulation amount of a deposit that accumulates in an injection hole of the first injection unit, the setting unit being configured to set the distribution ratio such that fuel is injected from the first injection unit of the first and second injection units when the accumulation amount estimated by the estimation unit is larger than a predetermined value in a predetermined case, the predetermined case being a case where the valve actuating device closes the exhaust valve on an advance side with respect to an exhaust top dead center of the piston and a state where a minus overlap is formed between the intake valve and the exhaust valve is established and a case where the distribution ratio is set such that fuel is injected from the second injection unit of the first and second injection units.

In the first aspect of the invention, the estimation unit may be configured to estimate the accumulation amount of the deposit that accumulates in the injection hole of the first injection unit on the basis of at least an amount of the minus overlap that is formed when the valve actuatin_{g} device is placed in the predetermined case and a duration of the predetermined case.

According to the first aspect of the invention, it is possible to prevent or suppress accumulation of a deposit in the injection hole of the injection unit that injects fuel into the intake passage due to blow-back of gas in the predetermined case.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic configuration view of an internal combustion engine;

FIG. 2 is a view that shows an exhaust system of the internal combustion engine;

FIG. 3A and FIG. 3B are graphs that illustrate estimation that is carried out by an estimation unit;

FIG. 4 is a graph that illustrates the amount of adhered fuel;

FIG. 5 is a first time chart that illustrates correction control;

FIG. 6 is a second time chart that illustrates correction control;

FIG. 7 is a first view of a flowchart that shows a control operation example;

FIG. 8 is a second view of the flowchart that shows the control operation example;

FIG. 9 is a third view of the flowchart that shows the control operation example;

FIG. 10 is a fourth view of the flowchart that shows the control operation example;

FIG. 11A and FIG. 11B are views that illustrate a minus overlap;

FIG. 12 is a view that illustrates a state where injected fuel adheres; and

FIG. 13 is a view that illustrates formation of a deposit.

### DETAILED DESCRIPTION OF EMBODIMENTS

An embodiment of the invention will be described with reference to the accompanying drawings.

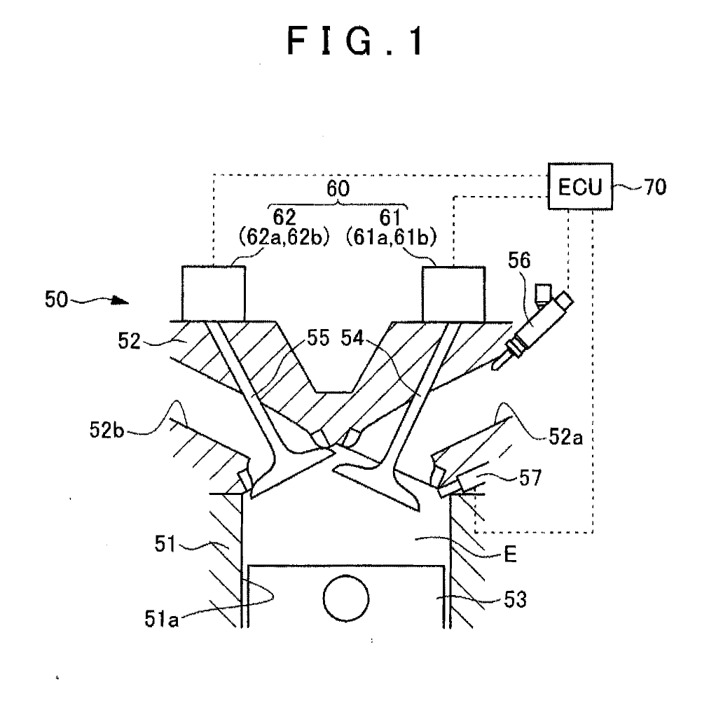

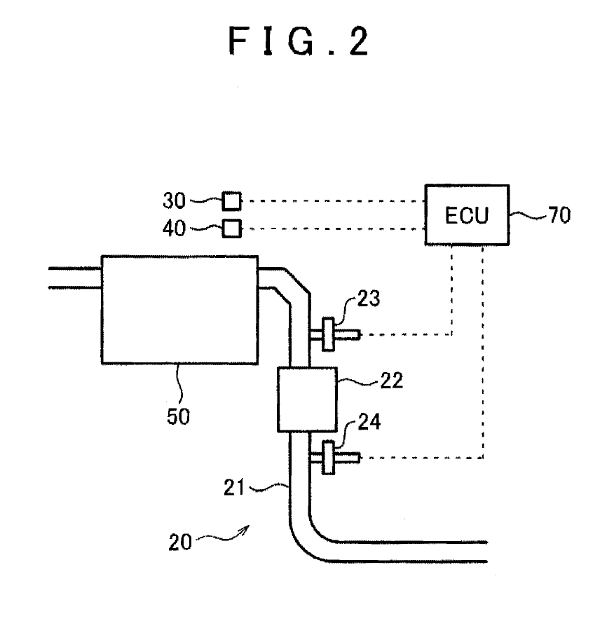

FIG. 1 is a schematic configuration view of an internal combustion engine 50. FIG. 2 is a view that shows an exhaust system 20 of the internal combustion engine 50. The internal combustion engine 50 is a spark ignition internal combustion engine, and includes a cylinder block 51, a cylinder head 52, a piston 53, an intake valve 54, an exhaust valve 55, a first fuel injection valve 56, a second fuel injection valve 57, a valve actuating device 60 and an ECU 70.

A cylinder 51a is formed in the cylinder block 51. The piston 53 is accommodated in the cylinder 51a. The cylinder head 52 is fixed to the upper face of the cylinder block 51. A combustion chamber E is formed as a space surrounded by the cylinder block 51, the cylinder head 52 and the piston 53. The piston 53 is located adjacent to the combustion chamber E.

An intake port 52a and an exhaust port 52b are formed in the cylinder head 52. The intake port 52a guides intake air to the combustion chamber E. The exhaust port 52b exhausts gas from the combustion chamber E. The intake valve 54 and the exhaust valve 55 are provided on the cylinder head 52. The intake valve 54 opens or closes the intake port 52a. The exhaust valve 55 opens or closes the exhaust port 52b. The intake port 52a forms an intake passage. The intake passage communicates with the combustion chamber E.

The first and second fuel injection valves 56, 57 both are provided on the cylinder head 52. The first fuel injection valve 56 injects fuel into the intake passage formed by the intake port 52a. The second fuel injection valve 57 injects fuel into the combustion chamber E. The second fuel injection valve 57 is provided at the intake-side portion of both the intake side and exhaust side of the cylinder head 52. Arrangement of the second fuel injection valve 57 is not necessarily limited to this configuration. The first fuel injection valve 56 corresponds to a first injection unit. The second fuel injection valve 57 corresponds to a second injection unit.

The valve actuating device 60 is provided on the cylinder head 52. The valve actuating device 60 includes an intake-side variable valve actuating mechanism 61 and an exhaust-side variable valve actuating mechanism 62. The intake-side variable valve actuating mechanism 61 is able to change the valve characteristics of the intake valve 54. The exhaust-side variable valve actuating mechanism 62 is able to change the valve characteristics of the exhaust valve 55.

The intake-side variable valve actuating mechanism 61 is configured to have an intake-side variable valve timing mechanism 61a and an intake-side variable lift amount mechanism 61b. The intake-side variable valve timing mechanism 61a changes the open and close timings of the intake valve 54. The intake-side variable lift amount mechanism 61b changes the angle of action (opening period) of the intake valve 54. The exhaust-side variable valve actuating mechanism 62 is configured to have an exhaust-side variable valve timing mechanism 62a and an exhaust-side variable lift amount mechanism 62b. The exhaust-side variable valve timing mechanism 62a changes the open and close timings of the exhaust valve 55. The exhaust-side variable lift amount mechanism 62b changes the angle of action of the exhaust valve 55.

Each of the variable valve timing mechanisms 61a, 62a is specifically of a hydraulically driven type, and is configured to include an oil control unit that controls transfer of hydraulic pressure. Each of the variable lift amount mechanisms 61b, 62b is specifically of an electrically driven type, and is configured to include an electric actuator. The electric actuator is, for example, a control motor. Each of the variable lift amount mechanisms 61b, 62b may be, for example, of a hydraulically driven type as in the case of each of the variable valve timing mechanisms 61a, 62a.

The intake-side variable lift amount mechanism 61b is configured to change the open timing of the intake valve 54 by changing the angle of action of the intake valve 54. The intake-side variable lift amount mechanism 61b is specifically configured such that the open timing of the intake valve 54 advances at the time when the angle of action expands and the open timing of the intake valve 54 retards at the time when the angle of action narrows. The intake-side variable lift amount mechanism 61b is further specifically configured such that the close timing of the intake valve 54 retards at the time when the angle of action expands and the close timing of the intake valve 54 advances at the time when the angle of action narrows.

The exhaust-side variable lift amount mechanism 62b is configured to change the close timing of the exhaust valve 55 by changing the angle of action of the exhaust valve 55. The exhaust-side variable lift amount mechanism 62b is specifically configured such that the close timing of the exhaust valve 55 retards at the time when the angle of action expands and the close timing of the exhaust valve 55 advances at the time when the angle of action narrows. The exhaust-side variable lift amount mechanism 62b is further specifically configured such that the open timing of the exhaust valve 55 advances at the time when the angle of action expands and the open timing of the exhaust valve 55 retards at the time when the angle of action narrows.

The exhaust-side variable valve actuating mechanism 62 is able to change the close timing of the exhaust valve 55 by changing the open and close timings of the exhaust valve 55 with the use of the exhaust-side variable valve timing mechanism 62a. The exhaust-side variable valve actuating mechanism 62 is also able to change the close timing of the exhaust valve 55 by changing the angle of action of the exhaust valve 55 with the use of the exhaust-side variable lift amount mechanism 62b.

Because the valve actuating device 60 includes the exhaust-side variable valve actuating mechanism 62, the valve actuating device 60 serves as a valve actuating device that changes at least the close timing of the exhaust valve 55 in the valve characteristics of the intake valve 54 and exhaust valve 55. The valve actuating device is allowed to be configured to include at least the exhaust-side variable valve actuating mechanism 62 of the intake-side variable valve actuating mechanism 61 and the exhaust-side variable valve actuating mechanism 62. The exhaust-side variable valve actuating mechanism 62 of the valve actuating device is allowed to be configured to include at least one of the exhaust-side variable valve timing mechanism 62a and the exhaust-side variable lift amount mechanism 62b. The valve actuating device is not necessarily limited to the above configuration, and may be another valve actuating device that is able to change the close timing of the exhaust valve 55.

The exhaust system 20 is connected to the internal combustion engine 50. The exhaust system 20 includes an exhaust pipe 21 and a catalyst 22. The exhaust pipe 21 forms an exhaust passage. The exhaust passage communicates with the combustion chamber E. The catalyst 22 is interposed in the exhaust pipe 21. The catalyst 22 purifies exhaust gas from the internal combustion engine 50.

The catalyst 22 is specifically a three-way catalyst. The catalyst 22 oxidizes hydrocarbons (HC) and carbon monoxide (CO) and reduces nitrogen oxides (NOx). The catalyst 22 has a property of releasing oxygen when the air-fuel ratio of exhaust gas is rich and occluding oxygen when the air-fuel ratio is lean (oxygen storage capability). An A/F sensor 23 is provided at a portion upstream of the catalyst 22 in the exhaust pipe 21. The A/F sensor 23 is used to detect the air-fuel ratio linearly on the basis of an oxygen concentration in exhaust gas. An oxygen sensor 24 is provided at a portion downstream of the catalyst 22 in the exhaust pipe 21. The oxygen sensor 24 is used to detect whether the air-fuel ratio of exhaust gas is richer than a stoichiometric air-fuel ratio (here, 14.7) or leaner than the stoichiometric air-fuel ratio.

The ECU 70 is an electronic control unit. The valve actuating device 60 (specifically, the oil control units and electric actuators of the variable valve actuating mechanisms 61, 62) is electrically connected to the ECU 70 as a controlled target. The A/F sensor 23, the oxygen sensor 24, a first sensor group 30 and a second sensor group 40 are electrically connected as sensors and switches_{—} The first sensor group 30 is used to detect the operating state of the internal combustion engine 50. The second sensor group 40 is used to detect the state of the valve actuating device 60,

The first sensor group 30, for example, includes a crank angle sensor, an air flow meter, an accelerator operation amount sensor and a coolant temperature sensor, The crank angle sensor is able to detect the rotation speed of the internal combustion engine 50. The air flow meter measures the intake air amount of the internal combustion engine 50. The accelerator operation amount sensor issues an acceleration request to the internal combustion engine 50. The coolant temperature sensor senses the coolant temperature of the internal combustion engine 50. The second sensor group 40, for example, includes sensors for detecting the open and close timings of the intake valve 54 and the open and close timings of the exhaust valve 55 and sensors for detecting the set lift amount (or set angle of action) of the intake valve 54 and the set lift amount (or set angle of action) of the exhaust valve 55. The set lift amount is, for example, a lift amount that is understood by the maximum lift amount.

In the ECU 70, a CPU executes a process while utilizing a temporary storage area of a RAM where necessary on the basis of a program stored in a ROM, thus implementing, for example, the following control unit, setting unit, estimation unit, injection amount correction unit, ignition timing correction unit, correction target setting unit and determination unit. These components may be individually implemented by parts of components in a plurality of electronic control units.

The control unit controls the valve actuating device 60. The control unit, for example, controls the valve actuating device 60 such that the exhaust valve 55 is closed on the advance side with respect to the exhaust top dead center of the piston 53 and a minus overlap is formed between the intake valve 54 and the exhaust valve 55. The control unit, for example, controls the valve actuating device 60 as described above when the operating state of the internal combustion engine 50 is in a high-temperature low-load state including a high-temperature idling state. The valve actuating device 60 may be regarded as a component including the control unit.

The setting unit sets a distribution ratio of fuel between the fuel injection valves 56, 57. The setting unit, for example, sets the distribution ratio such that fuel is injected from the second fuel injection valve 57 of both the fuel injection valves 56, 57 when a required injection amount TAU is smaller than a minimum injection amount taumin. That is, the distribution ratio viewed from the second fuel injection valve 57 (hereinafter, simply referred to as the distribution ratio of the second fuel injection valve 57) is set to 100%.

The required injection amount TAU is a fuel injection amount that is required per cylinder of the internal combustion engine 50, and is an injection amount based on a required output. The minimum injection amount taumin is a predetermined fuel injection amount, and is specifically a fuel injection amount that is required for the second fuel injection valve 57 in order to prevent adhesion of a deposit to the injection hole of the second fuel injection valve 57. The minimum injection amount taumin is acquired and set in advance.

The estimation unit estimates an accumulation amount Spfi of a deposit that accumulates in the injection hole of the first fuel injection valve 56. The estimation unit specifically estimates the accumulation amount Spfi on the basis of at least the amount of a minus overlap that is formed when the valve actuating device 60 is placed in a predetermined case A and the duration of the predetermined case A.

The predetermined case A is a case where the valve actuating device 60 is placed in a state where the exhaust valve 55 closes on the advance side with respect to the exhaust top dead center of the piston 53 and a minus overlap is formed and the distribution ratio of the second fuel injection valve 57 is set to 100% (in other words, a case where fuel is injected from the second fuel injection valve 57 of both the fuel injection valves 56, 57). The estimation unit specifically estimates the accumulation amount Spfi in the predetermined case A.

The setting unit sets the distribution ratio in the predetermined case A such that fuel is injected from the first fuel injection valve 56 of both the fuel injection valves 56, 57 when the accumulation amount Spfi is larger than a predetermined value Xpfi (here, larger than or equal to the predetermined value Xpfi). That is, the distribution ratio viewed from the first fuel injection valve 56 (hereinafter, simply referred to as the distribution ratio of the first fuel injection valve 56) is set to 100%.

At the time of estimating the accumulation amount Spfi, the estimation unit further specifically estimates the accumulation amount Spfi when the valve actuating device 60 cannot eliminate a minus overlap in the predetermined case A. The case where the minus overlap cannot be eliminated is the case where it is not possible to retard the close timing of the exhaust valve 55 to a position at which the minus overlap is eliminated and it is not possible to advance the open timing of the intake valve 54 to a position at which the minus overlap is eliminated.

When the valve actuating device 60 is allowed to eliminate the minus overlap in the predetermined case A, the control unit controls the valve actuating device 60 such that the minus overlap is eliminated. The control unit specifically controls the valve actuating device 60 to eliminate the minus overlap by carrying out any one of retardation of the open and close timings of the exhaust valve 55, expansion of the angle of action of the intake valve 54 and expansion of the angle of action of the exhaust valve 55.

When the valve actuating device 60 is able to carry out at least two operations of the plurality of operations (here, retardation of the open and close timings of the exhaust valve 55, expansion of the angle of action of the intake valve 54 and expansion of the angle of action of the exhaust valve 55), the valve actuating device 60 is able to eliminate the minus overlap by carrying out any one of these operations. In this case, the valve actuating device 60 is, for example, able to carry out any one of these operations in this order of priority. An operation that is carried out by the valve actuating device 60 may be at least any one of the above-described plurality of operations.

The estimation unit further estimates an accumulation amount Sdi of a deposit that accumulates in the injection hole of the second fuel injection valve 57. The estimation unit estimates the accumulation amount Sdi when the distribution ratio of the first fuel injection valve 56 is set to 100%. The estimation unit specifically estimates the accumulation amount Sdi on the basis of at least the duration of the case where the distribution ratio of the first fuel injection valve 56 is set to 100%.

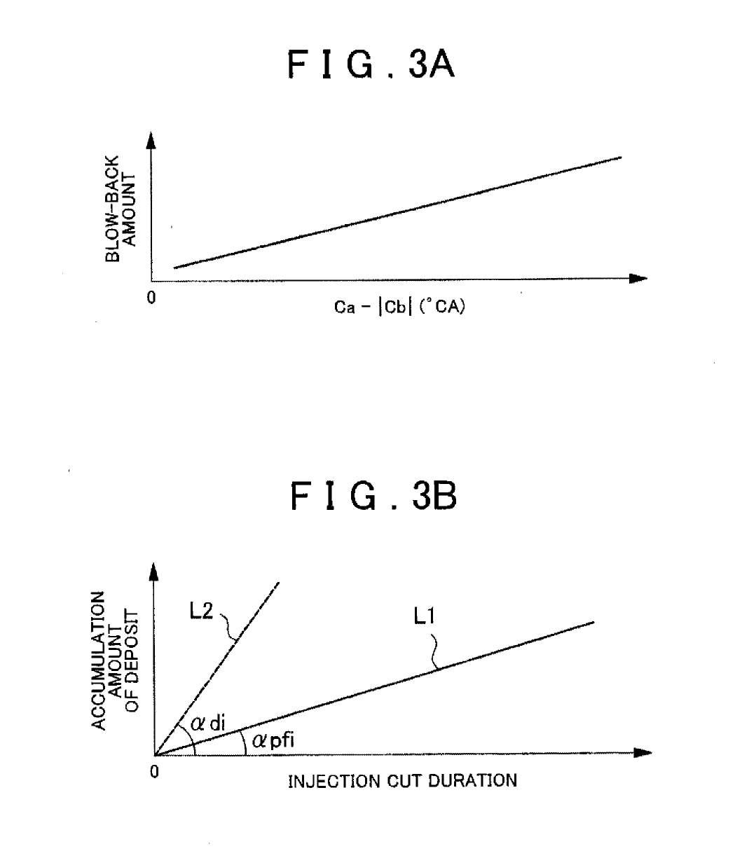

FIG. 3A and FIG. 3B are graphs that illustrate estimation that is carried out by the estimation unit. FIG. 3A is a graph that shows a blow-back amount of gas based on a minus overlap amount. FIG. 3B is a graph that shows the accumulation amount of a deposit based on an injection cut duration.

In FIG. 3A, Ca−|Cb| indicates a minus overlap amount in the case where Ca−|Cb| is larger than zero. A period Ca is a period between the close timing of the exhaust valve 55 and the exhaust top dead center. A period Cb is a period between the exhaust top dead center and the open timing of the intake valve 54. The period Ca is positive when the close timing of the exhaust valve 55 and the exhaust top dead center come in this order. The period Cb is positive when the exhaust top dead center and the open timing of the intake valve 54 come in this order. Thus, the open timing of the intake valve 54 may be, for example, set on the advance side with respect to the exhaust top dead center. The blow-back amount is the amount of gas blown back to the intake port 52a.

In FIG. 3B, the injection cut duration indicates an injection cut duration of the first fuel injection valve 56 for a straight line L1, and indicates an injection cut duration of the second fuel injection valve 57 for a straight line L2. The straight line L1 indicates the case of the first fuel injection valve 56. The straight line L2 indicates the case of the second fuel injection valve 57. The accumulation amount of a deposit indicates the accumulation amount Spfi for the straight line L1, and indicates the accumulation amount Sdi for the straight line L2. A deposit coefficient αpfi indicates the slope of the straight line L1. A deposit coefficient αdi indicates the slope of the straight line L2.

As shown in FIG. 3A, the blow-back amount of gas increases as the minus overlap amount increases. The injection hole of the first fuel injection valve 56 is more easily exposed to oxidizing agent under a high temperature as the blow-back amount of gas increases. As a result, a deposit more easily accumulates in the injection hole of the first fuel injection valve 56. Therefore, the estimation unit is able to reflect the influence of the blow-back amount of gas on the accumulation amount Spfi by estimating the accumulation amount Spfi on the basis of the minus overlap amount.

As shown in FIG. 3B, the accumulation amount of a deposit increases as the injection cut duration extends. When the straight line L1 is observed, the injection cut duration is the same as the duration of the predetermined case A. Therefore, the estimation unit is able to reflect the influence of the injection cut duration on the accumulation amount Spfi by estimating the accumulation amount Spfi on the basis of the duration of the predetermined case A. On the other hand, when the straight line L2 is observed, the injection cut duration is the same as the duration of the case where the distribution ratio of the first fuel injection valve 56 is set to 100%. Therefore, the estimation unit is able to reflect the influence of the injection cut duration on the accumulation amount Sdi by estimating the accumulation amount Sdi on the basis of the duration.

At the time of estimating the accumulation amount Spfi,the estimation unit further specifically estimates the accumulation amount Spfi on the basis of the straight line L1. The straight line L1 is a straight line that has the deposit coefficient αpfi as a slope and that sets the accumulation amount Spfi on the basis of the injection cut duration. Thus, the duration of the predetermined case A is considered in the straight line L1. In the straight line L1, the deposit coefficient αpfi reflects the influence of the amount of blow-back of gas. The deposit coefficient αpfi additionally reflects the injector characteristics (for example, an injection hole diameter, and the like) including the arrangement characteristics of the first fuel injection valve 56.

At the time of estimating the accumulation amount Sdi, the estimation unit further specifically estimates the accumulation amount Sdi on the basis of the straight line L2. The straight line L2 is a straight line that has the deposit coefficient αdi as a slope and that sets the accumulation amount Sdi on the basis of the injection cut duration. Thus, the duration of the case where the distribution ratio of the first fuel injection valve 56 is set to 100% is considered in the straight line L2. The deposit coefficient αdi reflects the injector characteristics including the arrangement characteristics of the second fuel injection valve 57.

The deposit coefficient αdi is set so as to be larger than the deposit coefficient αpfi. This is because, due to the injector characteristics, the injection hole of the second fuel injection valve 57 that injects fuel into the combustion chamber E is more easily exposed to high-temperature gas and a large amount of oxidizing agent than the injection hole of the first fuel injection valve 56. The deposit coefficients αpfi, αdi may be acquired and set in advance.

When the estimation unit is not able to estimate the accumulation amount Sdi or the accumulation amount Spfi, the setting unit sets the distribution ratio such that fuel is alternately injected between the fuel injection valves 56, 57 in each one combustion cycle. That is the distribution ratios of these fuel injection valves 56, 57 are alternately set to 100% in each one combustion cycle. The case where the estimation unit is not able to estimate the accumulation amount Sdi or the accumulation amount Spfi is, for example, the case where the estimation accuracy has decreased due to aged degradation.

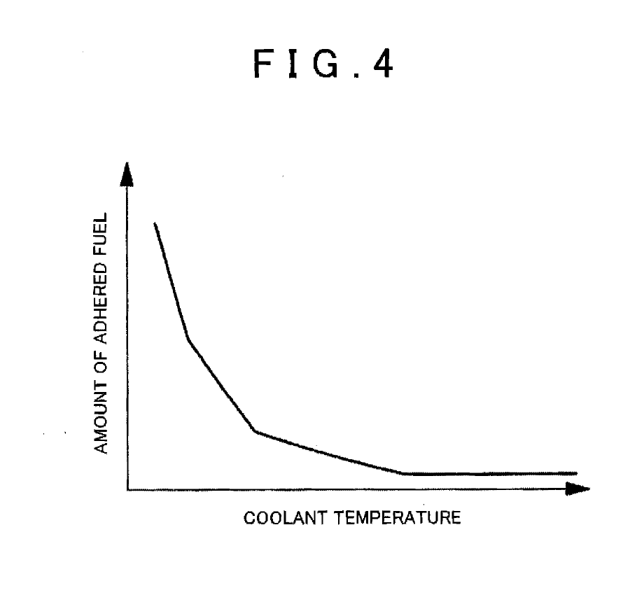

The injection amount correction unit corrects the fuel injection amount such that the fuel injection amount is increased. The ignition timing correction unit corrects the ignition timing such that the ignition timing is advanced. A phenomenon that will be described below is considered in increasing correction that is performed by the injection amount correction unit and advance correction that is performed by the ignition timing correction unit. FIG. 4 is a graph that illustrates the amount of adhered fuel. In FIG. 4, the ordinate axis represents the amount of adhered fuel that is injected from the first fuel injection valve 56 and adheres to the intake port 52a or the intake valve 54. The abscissa axis represents the coolant temperature of the internal combustion engine 50. As shown in FIG. 4, the amount of adhered fuel reduces as the coolant temperature of the internal combustion engine 50 increases.

Therefore, the injection amount correction unit specifically corrects the fuel injection amount such that the fuel injection amount is increased by the amount corresponding to a reduction in torque due to adhered fuel on the basis of the coolant temperature of the internal combustion engine 50. The ignition timing correction unit corrects the ignition timing such that the ignition timing is advanced by the amount corresponding to a reduction in torque due to adhered fuel on the basis of the coolant temperature of the internal combustion engine 50, The increased value in the case of increasing correction in this way and the advance amount in the case of advance correction in this way may be, for example, set in advance in map data on the basis of the coolant temperature of the internal combustion engine 50.

As for the timing of increasing correction, the injection amount correction unit specifically corrects the fuel injection amount such that the fuel injection amount is increased at the time when the setting unit sets the distribution ratio of the first fuel injection valve 56 to 100%. As for the timing of advance correction, the ignition timing correction unit specifically collects the ignition timing such that the ignition timing is advanced at the time when the setting unit sets the distribution ratio of the first fuel injection valve 56 to 100%. At the time of correcting the fuel injection amount such that the fuel injection amount is increased, the injection amount correction unit specifically extends the fuel injection period.

At the time of performing increasing correction or advance correction, in the internal combustion engine 50, specifically, one of the injection amount correction unit and the ignition timing correction unit performs correction. In terms of this point, in the internal combustion engine 50, the correction target setting unit sets a correction target to one of the fuel injection amount and the ignition timing. When the correction target is set to the fuel injection amount, the injection amount correction unit corrects the fuel injection amount such that the fuel injection amount is increased. When the correction target is set to the ignition timing, the ignition timing correction unit corrects the ignition timing such that the ignition timing is advanced.

The correction target setting unit specifically sets the correction target to one of the fuel injection amount and the ignition timing when the accumulation amount Spfi is larger than the predetermined value Xpfi in the predetermined case A. At the time when the correction target setting unit sets the correction target, a phenomenon that will be described below is considered.

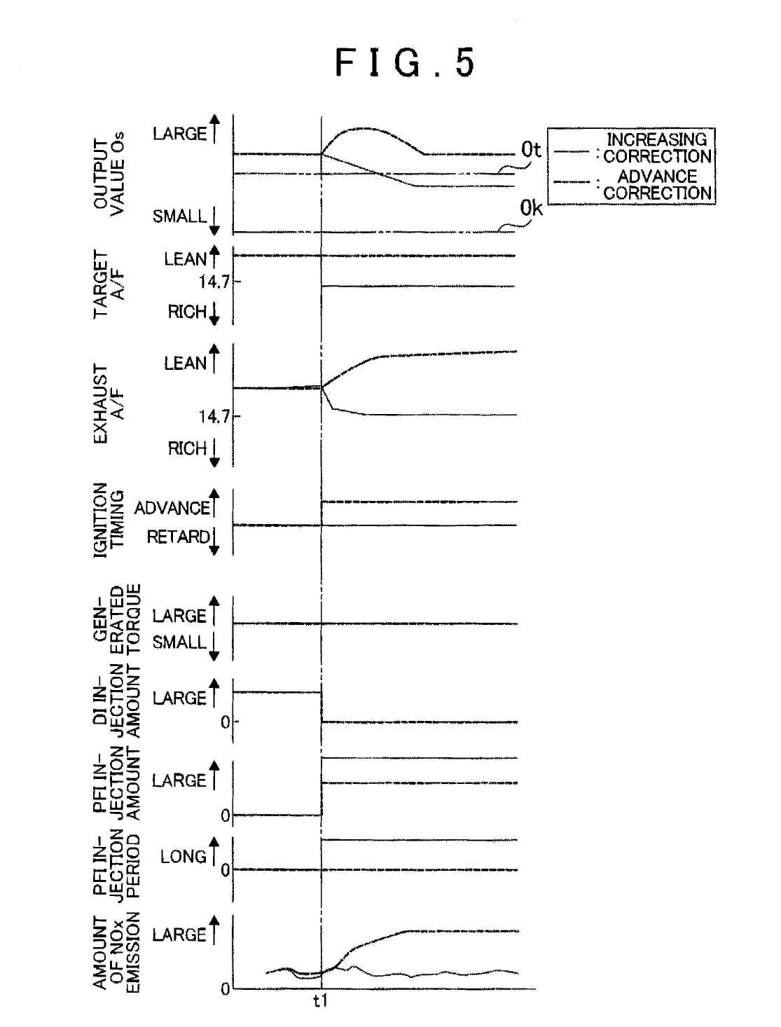

FIG. 5 is a first time chart that illustrates correction control. In FIG. 5, the ordinate axis represents various parameters, and the abscissa axis represents time. FIG. 5 shows variations in various parameters in the case where s space inside the catalyst 22 is a reduction atmosphere. In FIG. 5, the output value Os of the oxygen sensor 24, the target air-fuel ratio (A/F), the exhaust A/F, the ignition timing, the generated torque, the DI injection amount, the PFI injection amount, the PFI injection period and the amount of NOx emitted from the catalyst 22 are shown as various parameters. The DI injection amount is the fuel injection amount of the second fuel injection valve 57. The PFI injection amount is the fuel injection amount of the first fuel injection valve 56. The PFI injection period is the fuel injection period of the first fuel injection valve 56. The continuous line indicates the case of increasing correction. The dashed line indicates the case of advance correction.

Here, before FIG. 5 is specifically described, first, control over the target A/F will be described. The target A/F is controlled as follows in the internal combustion engine 50. That is, the target A/F is controlled so as to become rich when the output value Os becomes smaller than the determination value Ok (when the oxygen storage amount is excessively large) and become lean when the output value Os becomes larger than the determination value Ot (when the oxygen storage amount is excessively small). Each of the determination values Ok, Ot is a determination value fur the output value Os at the time of controlling the target A/F in this way. The determination value Ok indicates a low oxygen concentration-side determination value, and the determination value Ot indicates a high oxygen concentration-side determination value.

As a result that the target A/F is controlled in the internal combustion engine 50 in this way, reverse operation that the target A/F increases after the output value Os becomes smaller than the determination value Ok and decreases after the output value Os becomes higher than the determination value Ot is repeated. In the internal combustion engine 50, the oxygen storage amount of the catalyst 22 is kept at an appropriate amount through control over the target A/F, and exhaust gas is appropriately purified.

Before time t1, the target A/F is set to be lean, and the exhaust A/F is lean. The space in the catalyst 22 is a reduction atmosphere, and the output value Os is larger than the determination value Ok. The fact that the space in the catalyst 22 is a reduction atmosphere may be determined on the basis of the fact that the output value Os becomes larger than the determination value Ot and, after that, has not become smaller than the determination value Ok. When the space in the catalyst 22 is a reduction atmosphere, the catalyst 22 purifies NOx by occluding oxygen. Before time t1, the PFI injection amount is zero.

At time t1, the distribution ratio of the first fuel injection valve 56 is set to 100%. Therefore, after time t1, the entire fuel to be injected is injected from the first fuel injection valve 56, and the DI injection amount becomes zero. In this case, fuel that is supplied to the combustion chamber E reduces by the amount of fuel adhered to the intake port 52a or the intake valve 54. Therefore, if this goes on, the generated torque of the internal combustion engine 50 decreases after time t1. In contrast, in order to suppress a decrease in the generated torque, for example, it is allowed to perform advance correction of the ignition timing at time t1.

Incidentally, in this case, the exhaust A/F becomes lean by the amount of adhered fuel. The oxygen storage amount of the catalyst 22 increases as the exhaust A/F becomes leaner. Therefore, in this case, the amount of NOx that is purified reduces by the amount by which the oxygen storage amount of the catalyst 22 increases. That is, the NOx purification rate decreases. As a result, the amount of NOx emission increases.

On the other hand, in order to suppress a decrease in the generated torque, it is allowed to perform increasing correction of the injection amount at time t1. In this case, by setting the target A/F such that the target A/F is richer than that before time t1, it is possible to also cause the exhaust A/F to become richer than that before time t1. As a result, by preventing or suppressing an increase in the oxygen storage amount of the catalyst 22 through enleaned A/F as described above, it is possible to prevent or suppress an increase in the amount of NOx emission. Thus, it is desirable to correct the injection amount such that the injection amount is increased when the space in the catalyst 22 is in a reduction atmosphere.

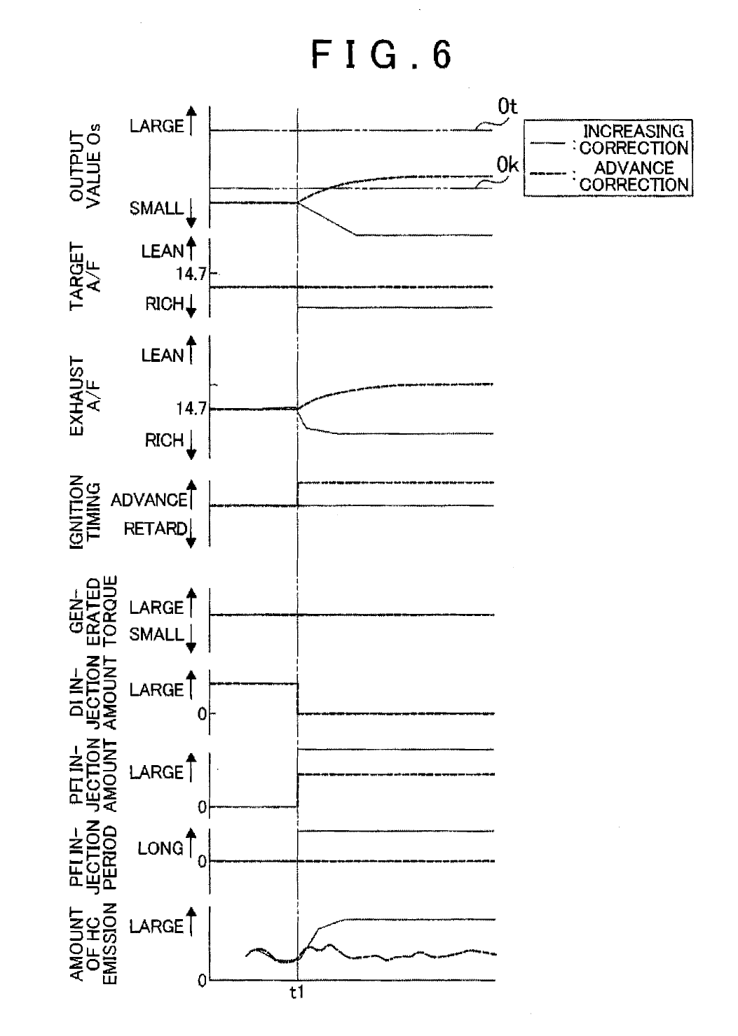

FIG. 6 is a second time chart that illustrates correction control. In FIG. 6, the ordinate axis represents various parameters, and the abscissa axis represents time. FIG. 6 shows variations in various parameters in the case where the space in the catalyst 22 is in an oxidation atmosphere. The various parameters shown in FIG. 6 are the same as the various parameters shown in FIG. 5 except that the amount of emission is shown instead of the amount of NOx emission. The continuous line indicates the case of increasing correction. The dashed line indicates the case of advance correction.

Before time t1, the target A/F is set so as to be rich, and the exhaust A/F is rich. The space in the catalyst 22 is in an oxidation atmosphere, so the output value Os is smaller than the determination value Ot. The fact that the space in the catalyst 22 is an oxidation atmosphere may be determined on the basis of the fact that the output value Os becomes smaller than the determination value Ok and, after that, has not become larger than the determination value Ot. When the space in the catalyst 22 is an oxidation atmosphere, the catalyst 22 purifies HC by releasing oxygen. Before time t1, the PFI injection amount is zero.

At time t1, the distribution ratio of the first fuel injection valve 56 is set to 100%. Therefore, after time t1, the DI injection amount becomes zero. In this case, if this goes on, the generated torque of the internal combustion engine 50 decreases after time t1. In contrast, in order to suppress a decrease in the generated torque after time t1, for example, it is allowed to perform increasing correction of the injection amount at time t1.

However, in this case, after time t1, the exhaust A/F becomes rich by the amount by which the amount of fuel is increased through increasing correction. The oxygen storage amount of the catalyst 22 reduces as the exhaust A/F becomes richer. Therefore, in this case, the amount of HC that is purified reduces by the amount by which the oxygen storage amount of the catalyst 22 reduces. As a result, the amount of HC emission increases.

On the other hand, in order to suppress a decrease in the generated torque after time t1, it is allowed to perform advance correction of the ignition timing at time t1, In this case, by avoiding a reduction in the oxygen storage amount of the catalyst 22 through enriched exhaust A/F as described above, it is possible to prevent or suppress an increase in the amount of HC emission. Thus, it is desirable to perform advance correction of the ignition timing when the space in the catalyst 22 is in an oxidation atmosphere.

In light of these, the correction target setting unit specifically sets the correction target to the fuel injection amount when the space in the catalyst 22 is in the reduction atmosphere, and sets the correction target to the ignition timing when the space in the catalyst 22 is in the oxidation atmosphere. In other words, the correction target setting unit that sets the correction target in this way sets the correction target on the basis of whether the oxygen storage amount of the catalyst 22 is increasing or reducing on the basis of the oxygen storage amount of the catalyst 22.

The case where the space in the catalyst 22 is in a reduction atmosphere may include a period from when the target A/F is controlled to be lean to when the space in the catalyst 22 actually becomes lean. Similarly, the case where the space in the catalyst 22 is in an oxidation atmosphere may include a period from when the target A/F is controlled to be rich to when the space in the catalyst 22 actually becomes rich.

The injection amount correction unit further cancels increasing correction. The injection amount correction unit specifically cancels increasing correction when the accumulation amount Sdi is larger than a predetermined value Xdi (here, larger than or equal to the predetermined value Xdi) in the case where the correction target is set to the fuel injection amount. The ignition timing correction unit further cancels advance correction. The ignition timing correction unit specifically cancels advance correction when the accumulation amount Sdi is larger than the predetermined value Xdi (here, larger than or equal to the predetermined value Xdi) in the case where the correction target is set to the ignition timing.

When the accumulation amount Sdi is larger than the predetermined value Xdi, the setting unit farther sets the distribution ratio of the second fuel injection valve 57 to 100%. In contrast, the injection amount correction unit specifically cancels increasing correction at the time when the setting unit sets the distribution ratio of the second fuel injection valve 57 to 100%. The ignition timing correction unit cancels advance correction at the time when the setting unit sets the distribution ratio of the second fuel injection valve 57 to 100%.

The determination unit carries out various determinations. Each determination that is carried out by the determination unit will be described in the following description of the operation of the ECU 70. The determination unit may be, for example, regarded as a determination unit that carries out at least part of a plurality of different determinations. In this case, the determination unit may be, for example, configured such that a plurality of different determination units (for example, first and second determination units) are present by determination contents.

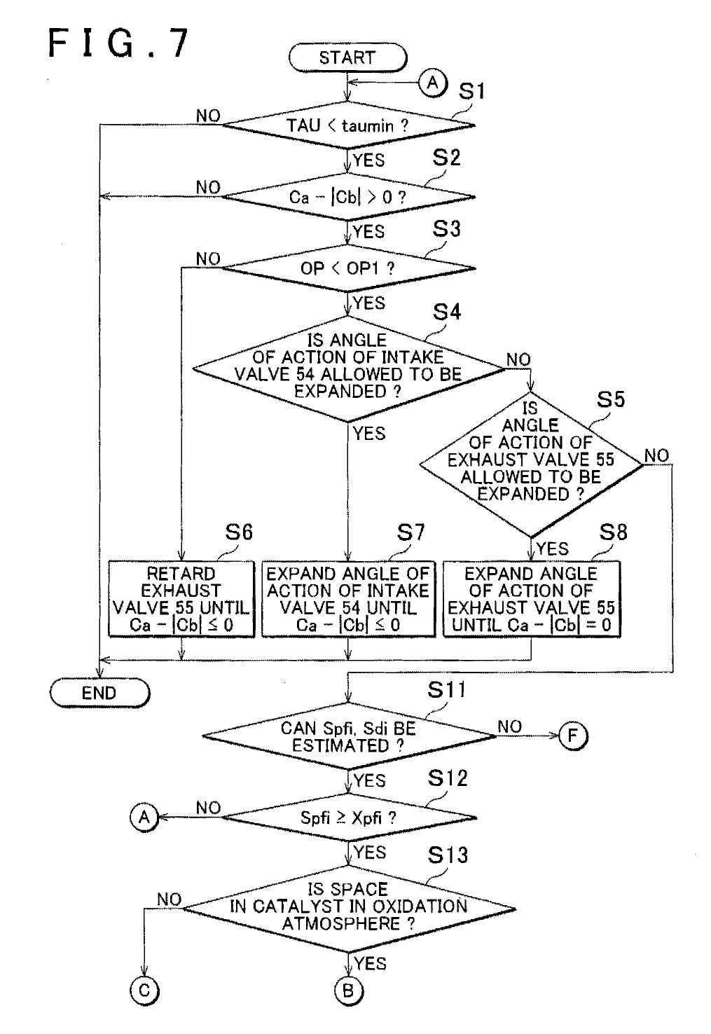

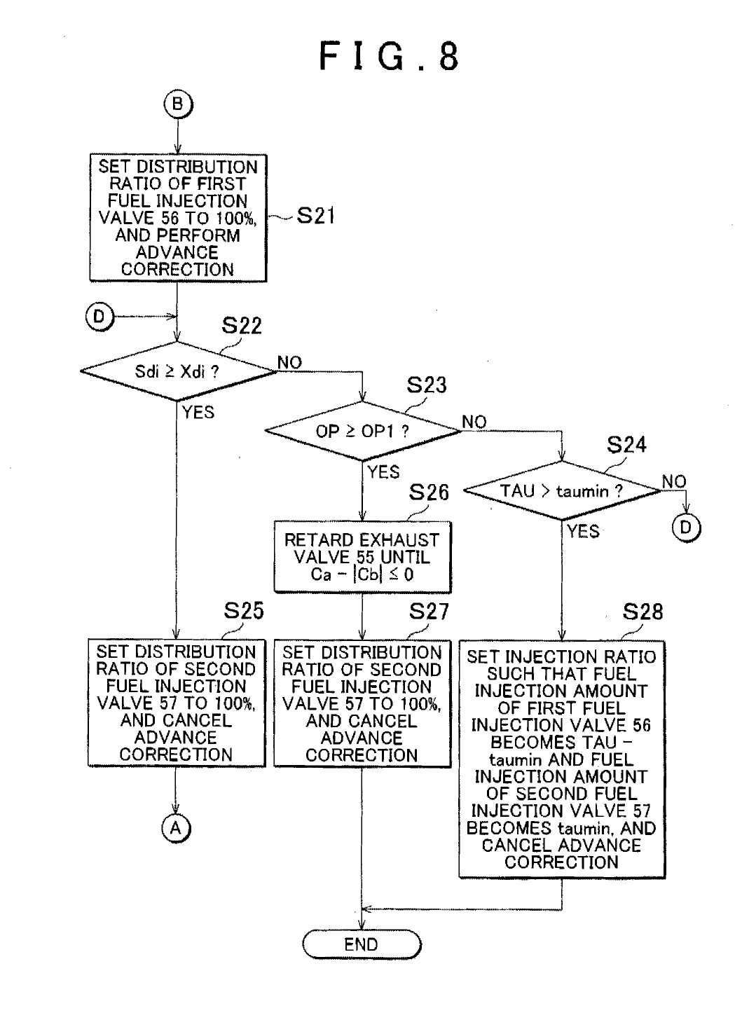

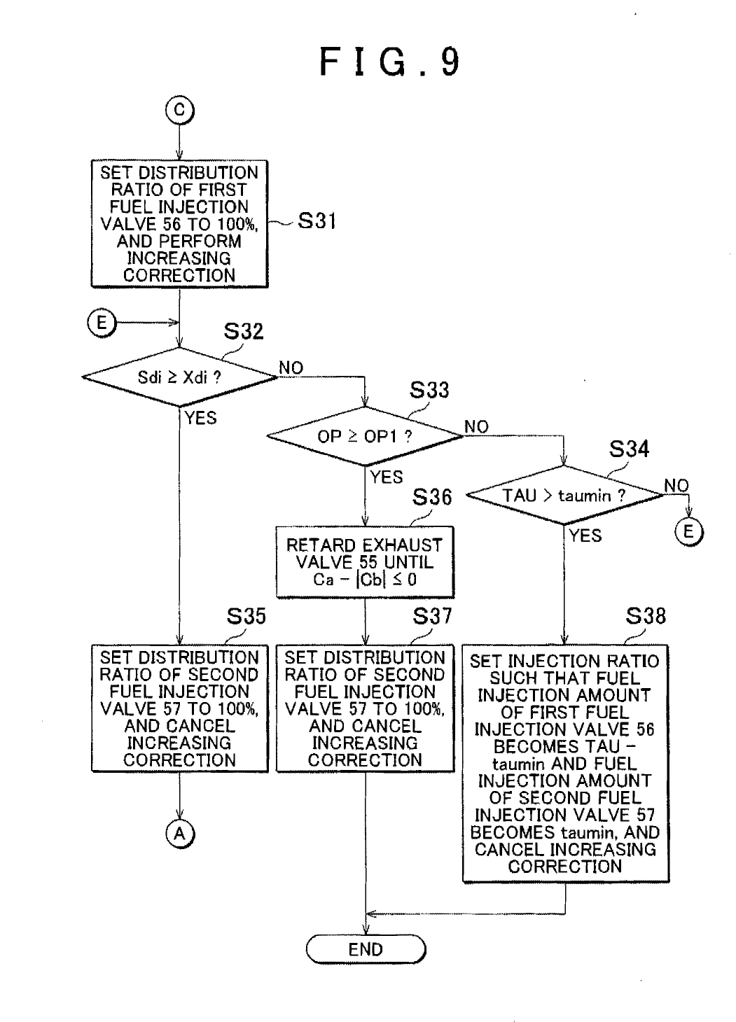

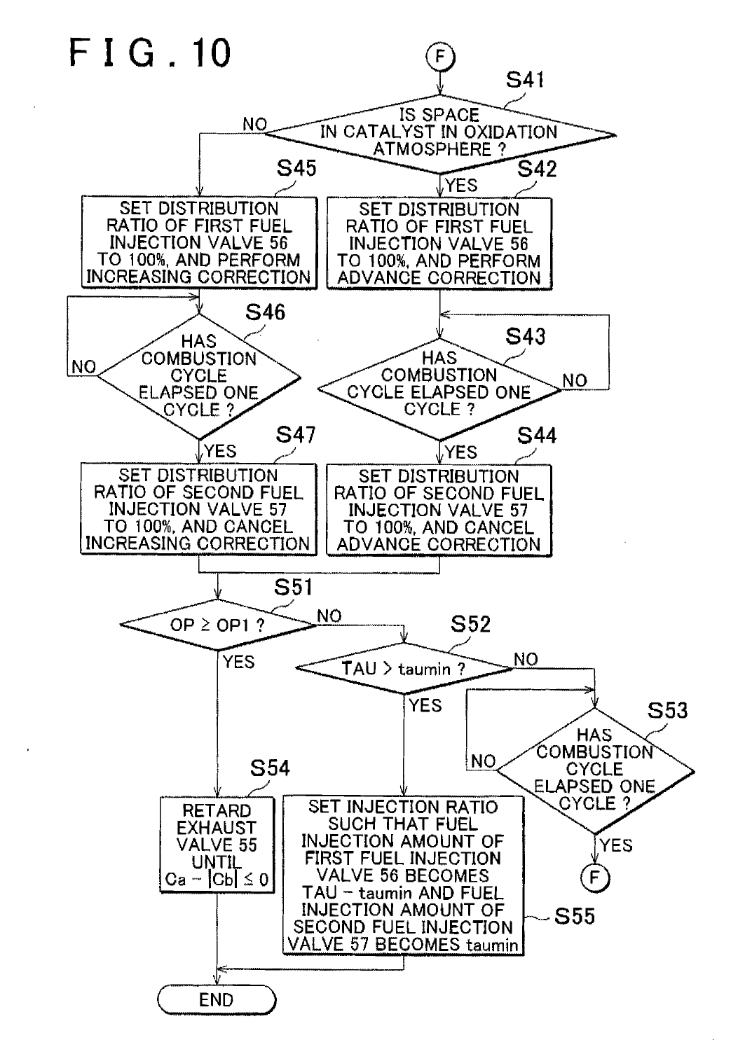

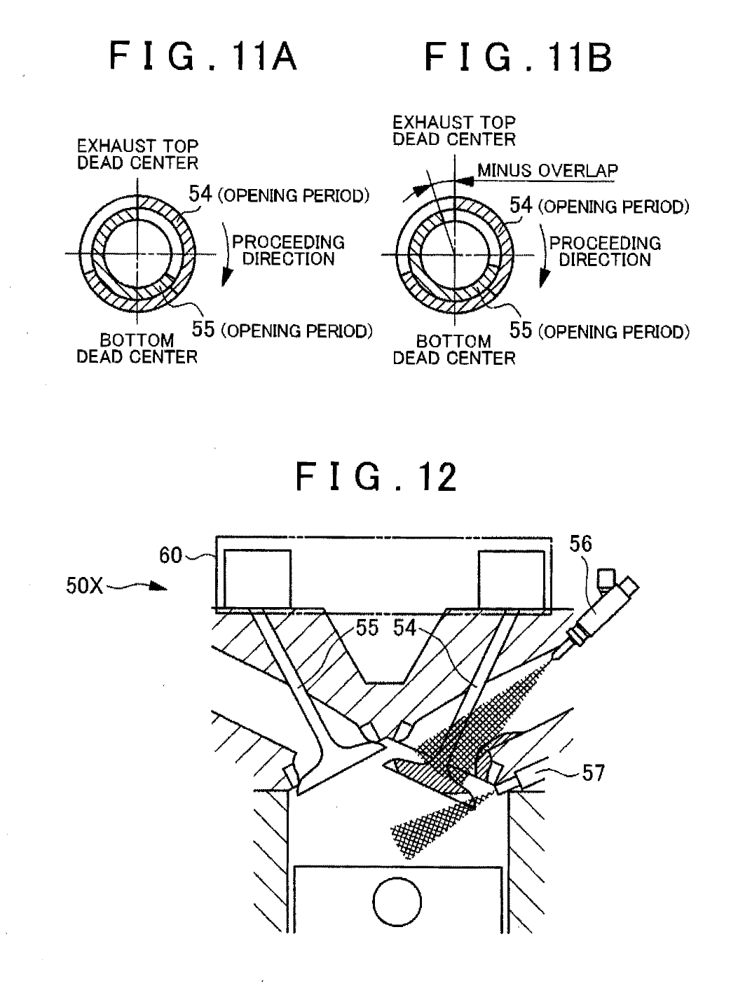

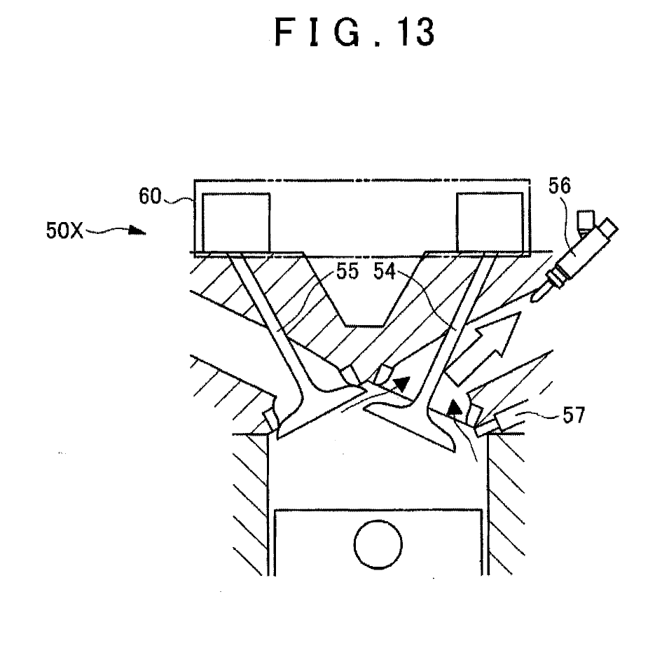

Next, an example of the control operation that is executed by the ECU 70 will be described with reference to the flowchart shown in FIG. 7 to FIG. 10. The ECU 70 determines whether the required injection amount TAU is smaller than the minimum injection amount taumin (step S1). When affirmative determination is made, the ECU 70 determines whether the periods Ca, Cb satisfy the relationship Ca−|Cb|>0 (whether a value obtained by subtracting the absolute value of the period Cb from the period Ca is larger than zero) (step S2).

In step S1, it is determined whether the distribution ratio of the second fuel injection valve 57 is set to 100%. In step S2, it is determined whether it is in a state where the exhaust valve 55 closes on the advance side with respect to the exhaust top dead center and a minus overlap is formed. Thus, when affirmative determination is made in step S1 and step S2, it is determined that it is the predetermined case A.

When affirmative determination is made in step S2, the ECU 70 determines whether the hydraulic pressure OP is lower than a working allowable pressure OP1 (step S3). The hydraulic pressure OP is a hydraulic pressure that is applied to the valve actuating device 60. The working allowable pressure OP1 is a hydraulic pressure required to ensure the operation of the exhaust-side variable valve timing mechanism 62a. When negative determination is made in step S3, it is determined that the operation of the exhaust-side variable valve timing mechanism 62a is ensured. In this case, at the same time, it is determined that it is allowed to retard the close timing of the exhaust valve 55 to a position at which the minus overlap is eliminated.

Therefore, when negative determination is made in step S3, the ECU 70 retards the exhaust valve 55 until the periods Ca, Cb satisfy the relationship Ca−|Cb|≦0 (step S6). In step S6, the ECU 70 specifically retards the open and close timings of the exhaust valve 55 by controlling the exhaust-side variable valve timing mechanism 62a. When affirmative determination is made in step S3, the ECU 70 determines whether the angle of action of the intake valve 54 is allowed to be expanded (step S4).

In step S4, specifically, it is determined whether it is allowed to advance the open timing of the intake valve 54 to a position at which the minus overlap is eliminated. In contrast, whether the angle of action of the intake valve 54 is allowed to be expanded can be, for example, determined on the basis of whether the relationship Cb=Ca is achieved within the range in which the lift amount is changeable on the basis of the set lift amount of the intake valve 54. Whether the angle of action of the intake valve 54 is allowed to be expanded may be, for example, further determined by determining whether there is no interference between the piston 53 and the intake valve 54 in the case where Cb=Ca or determining whether the close timing of the intake valve 54 does not retard beyond a predetermined position.

When affirmative determination is made in step S4, the ECU 70 expands the angle of action of the intake valve 54 until the periods Ca, Cb satisfy the relationship Ca−|Cb|≦0 (step S7). In step S7, the ECU 70 specifically expands the angle of action of the intake valve 54 by controlling the intake-side variable lift amount mechanism 61b. When negative determination is made in step S4, the ECU 70 determines whether the angle of action of the exhaust valve 55 is allowed to be expanded (step S5).

In step S5, specifically, it is determined whether the close timing of the exhaust valve 55 is allowed to be retarded to a position at which the minus overlap is eliminated. In contrast, whether the angle of action of the exhaust valve 55 is allowed to be expanded may be, for example, determined on the basis of whether the relationship Ca=Cb is achieved within the range in which the lift amount is changeable on the basis of the set lift amount of the exhaust valve 55. Whether the angle of action of the exhaust valve 55 is allowed to be expanded may be, for example, further determined by determining whether there is no interference between the piston 53 and the exhaust valve 55 in the case where Ca=Cb or determining whether the open timing of the exhaust valve 55 does not advance beyond a predetermined position.

When affirmative determination is made in step S5, the ECU 70 expands the angle of action of the exhaust valve 55 until the periods Ca, Cb satisfy the relationship Ca−|Cb|=0 (step C8). In step S8, the ECU 70 specifically expands the angle of action of the exhaust valve 55 by controlling the exhaust-side variable lift amount mechanism 62b.

When negative determination is made in step S1 or step S2 or after step S6, step S7 or step S8, the flowchart once ends. When negative determination is made in step S5, it is determined that it is not allowed to retard the close timing of the exhaust valve 55 to a position at which the minus overlap is eliminated and it is not allowed to advance the open timing of the intake valve 54 to a position at which the minus overlap is eliminated. That is, it is determined that the minus overlap cannot be eliminated.

Therefore, when negative determination is made in step S5, the ECU 70 determines whether it is possible to estimate the accumulation amount Spfi and the accumulation amount Sdi (step S11). Whether it is possible to estimate the accumulation amount Spfi and the accumulation amount Sdi may be, for example, determined by determining whether the total operation time of the internal combustion engine 50 exceeds a predetermined period of time. Whether it is possible to estimate the accumulation amount Spfi and the accumulation amount Sdi may be determined by determining whether it is in a state where the estimation accuracy decreases due to not only the influence of aged degradation but also, for example, another influence.

When affirmative determination is made, the ECU 70 estimates the accumulation amount Spfi, and determines whether the estimated accumulation amount Spfi is larger than or equal to the predetermined value Xpfi (step S12). When negative determination is made, the process returns to step S1. When affirmative determination is made in step S12, the ECU 70 determines whether the space in the catalyst 22 is in an oxidation atmosphere (step S13). Whether the space in the catalyst 22 is in an oxidation atmosphere may be, for example, determined on the basis of whether the output value Os becomes smaller than the determination value Ok and, after that, has not become larger than the determination value Ot. When affirmative determination is made in step S13, the correction target is set to the ignition timing.

Therefore, when affirmative determination is made in step S13, the ECU 70 sets the distribution ratio of the first fuel injection valve 56 to 100%, and performs advance correction of the ignition timing (step S21). Subsequently, the ECU 70 estimates the accumulation amount Sdi, and determines whether the estimated accumulation amount Sdi is larger than or equal to the predetermined value Xdi (step S22).

When negative determination is made, the ECU 70 determines that the hydraulic pressure OP is higher than or equal to the working allowable pressure OP1 (step S23). When negative determination is made, the ECU 70 determines whether the fuel injection amount TAU is larger than the minimum injection amount taurnin (step S24). In step S22 to step S24, it is determined whether the state where the distribution ratio of the first fuel injection valve 56 is set to 100% should be stopped or whether the state is allowed to be stopped. When negative determination is made in step S25, the process returns to step S22.

When affirmative determination is made in step S22, the ECU 70 sets the distribution ratio of the second fuel injection valve 57 to 100%, and cancels advance correction of the ignition timing (step S25). Thus, accumulation of a deposit in the injection hole of the second fuel injection valve 57 of both the fuel injection valves 56, 57 is preferentially prevented or suppressed. After step S25, the process returns to step S1.

When affirmative determination is made in step S23, the ECU 70 retards the exhaust valve 55 until the periods Ca, Cb satisfy the relationship Ca−|Cb|≦0 (step S26). That is, the minus overlap is eliminated. The distribution ratio of the second fuel injection valve 57 is set to 100%, and advance correction of the ignition timing is cancelled (step S27). After step S27, the flowchart once ends.

When affirmative determination is made in step S25, the ECU 70 sets the distribution ratio such that the fuel injection amount of the first fuel injection valve 56 becomes TAU—taumin (a value obtained by subtracting the minimum injection amount taumin from the required injection amount TAU) and the fuel injection amount of the second fuel injection valve 57 becomes the minimum injection amount taumin, and cancels advance correction of the ignition timing (step S28). After step S28, the flowchart once ends.

When negative determination is made in step S13, the correction target is set to the fuel injection amount. Therefore, when negative determination is made in step S13, the ECU 70 sets the distribution ratio of the first fuel injection valve 56 to 100%, and performs increasing correction of the fuel injection amount (step S31). Step S32 to step S38 are similar to step S22 to step S28 except that a cancellation of increasing correction is performed in step S35, step S37 or step S38 instead of a cancellation of advance correction is performed. Therefore, the description of these steps is omitted.

When negative determination is made in step S11, the ECU 70 determines whether the space in the catalyst 22 is in an oxidation atmosphere (step S41). When affirmative determination is made, the correction target is set to the ignition timing. Therefore, when affirmative determination is made, the ECU 70 sets the distribution ratio of the first fuel injection valve 56 to 100%, and performs advance correction of the ignition timing (step S42).

Subsequently, the ECU 70 determines whether the combustion cycle has elapsed one cycle after determination of the distribution ratio in step S42 (step S43). When negative determination is made, the process returns to step S43. When affirmative determination is made, the ECU 70 sets the distribution ratio of the second fuel injection valve 57 to 100%, and cancels advance correction of the ignition timing (step S44).

When negative determination is made in step S41, the ECU 70 sets the distribution ratio of the first fuel injection valve 56 to 100%, and performs increasing correction of the fuel injection amount (step S45). Subsequently, the ECU 70 determines whether the combustion cycle has elapsed one cycle after determination of the distribution ratio in step S45 (step S46). When negative determination is made, the process returns to step S46. When affirmative determination is made, the ECU 70 sets the distribution ratio of the second fuel injection valve 57 to 100%, and cancels increasing correction of the fuel injection amount (step S47).

Subsequent to step S44 or step S47, the ECU 70 determines whether the hydraulic pressure OP is higher than or equal to the working allowable pressure OP1 (step S51). When negative determination is made, the ECU 70 determines whether the fuel injection amount TAU is larger than the minimum injection amount taumin (step S52). When negative determination is made, the ECU 70 determines whether the combustion cycle has elapsed one cycle after determination of the distribution ratio in step S44 or step S47 (step S53). When negative determination is made, the process returns to step S53; whereas, when affirmative determination is made, the process returns to step S41. In step S51 and step S52, it is determined whether the state where the distribution ratios of these fuel injection valves 56, 57 are alternately set to 100% in each one combustion cycle is allowed to be stopped.

When affirmative determination is made in step S51, the ECU 70 retards the exhaust valve 55 such that the periods Ca, Cb satisfy the relationship Ca−|Cb|≦0 (step S54). When affirmative determination is made in step S52, the ECU 70 sets the distribution ratio such that the fuel injection amount of the first fuel injection valve 56 becomes TAU—taumin and the fuel injection amount of the second fuel injection valve 57 becomes the minimum injection amount taumin (step S55). After step S54 and step S55, the flowchart once ends.

Next, the major operation and advantageous effects of the internal combustion engine 50 will be described. The internal combustion engine 50 sets the distribution ratio of the first fuel injection valve 56 to 100% when the accumulation amount Spfi is larger than the predetermined value Xpfi in the predetermined case A. Therefore, the internal combustion engine 50 is able to prevent or suppress accumulation of a deposit in the injection hole of the first fuel injection valve 56 due to blow-back of gas in the predetermined case A.

The internal combustion engine 50 specifically estimates the accumulation amount Spfi of a deposit on the basis of at least the amount of a minus overlap that is formed when the valve actuating device 60 is in the predetermined case A and the duration of the predetermined case A. Thus, the internal combustion engine 50 is able to suitably estimate the accumulation amount Spfi by estimating the accumulation amount Spfi on which the influence of the minus overlap amount and the injection cut duration of the first fuel injection valve 56 are reflected.

The internal combustion engine 50 controls the valve actuating device 60 such that the minus overlap is eliminated when the valve actuating device 60 is able to eliminate the minus overlap in the predetermined case A. That is, the internal combustion engine 50 is also able to prevent or suppress accumulation of a deposit in the injection hole of the first fuel injection valve 56 by eliminating the minus overlap in the above case and reducing the amount of blow-back of gas.

The internal combustion engine 50 performs increasing correction of the fuel injection amount at the time when the distribution ratio of the first fuel injection valve 56 is set to 100%. Thus, the internal combustion engine 50 is able to prevent or suppress a reduction in torque by the amount of adhered fuel as a result of setting the distribution ratio of the first fuel injection valve 56 to 100%. The internal combustion engine 50 is able to prevent or suppress a reduction in torque by performing advance correction of the ignition timing as well at the time when the distribution ratio of the first fuel injection valve 56 is set to 100%. The internal combustion engine 50 is specifically able to prevent or suppress deterioration of drivability by preventing or suppressing a reduction in torque.

The internal combustion engine 50 sets the correction target to one of the fuel injection amount and the ignition timing, and sets the correction target on the basis of the oxygen storage amount of the catalyst 22. Specifically, the internal combustion engine 50 sets the correction target to the fuel injection amount when the space in the catalyst 22 is in a reduction atmosphere, and sets the correction target to the ignition timing when the space in the catalyst 22 is in an oxidation atmosphere. Thus, when the internal combustion engine 50 deals with a reduction in torque through increasing correction or advance correction, the internal combustion engine 50 is further able to prevent or suppress deterioration of exhaust emission.

The internal combustion engine 50 estimates the accumulation amount Sdi when the distribution ratio of the first fuel injection valve 56 is set to 100%, and sets the distribution ratio of the second fuel injection valve 57 to 100% when the accumulation amount Sdi is larger than or equal to the predetermined value Xdi. Thus, the internal combustion engine 50 is able to preferentially prevent or suppress adhesion of a deposit to the injection hole of the second fuel injection valve 57 of both the fuel injection valves 56, 57.

The thus configured internal combustion engine 50 is specifically able to cancel increasing correction at the time when the distribution ratio of the second fuel injection valve 57 is set to 100% in the case where the correction target is set to the fuel injection amount. The thus configured internal combustion engine 50 is specifically able to cancel advance correction at the time when the distribution ratio of the second fuel injection valve 57 is set to 100% in the case where the correction target is set to the ignition timing. Thus, it is possible to optimize the fuel injection amount and the ignition timing at the same time.

The internal combustion engine 50 alternately sets the distribution ratios of the fuel injection valves 56, 57 to 100% in each one combustion cycle when the accumulation amount Sdi or the accumulation amount Spfi cannot be estimated. Thus, the internal combustion engine 50 is able to prevent or suppress accumulation of a deposit in the injection holes of the fuel injection valves 56, 57 in the above case.

The embodiment of the invention is described in detail above; however, the invention is not limited to a specific embodiment. The invention may be variously modified or changed within the scope of the invention recited in the appended claims.

What is claimed is:

1. An internal combustion engine comprising:
an intake valve and an exhaust valve arranged in association with a combustion chamber;
a piston located to define the combustion chamber;
a first injection unit configured to inject fuel into an intake passage that communicates with the combustion chamber;
a second injection unit configured to inject fuel into the combustion chamber;
a valve actuating device configured to change at least close timing of the exhaust valve; and
a controller including a setting unit and an estimation unit, the setting unit being configured to set a distribution ratio of fuel between the first and second injection units, the estimation unit being configured to estimate an accumulation amount of a deposit that accumulates in an injection hole of the first injection unit,
the setting unit being configured to set the distribution ratio such that fuel is injected from the first injection unit of the first and second injection units when the accumulation amount estimated by the estimation unit is larger than a predetermined value in a predetermined case,
the predetermined case being a case where the valve actuating device closes the exhaust valve on an advance side with respect to an exhaust top dead center of the piston and a state where a minus overlap is formed between the intake valve and the exhaust valve is established and a case where the distribution ratio is set such that fuel is injected from the second injection unit of the first and second injection units.

2. The internal combustion engine according to claim 1, wherein
the estimation unit is configured to estimate the accumulation amount of the deposit that accumulates in the injection hole of the first injection unit on the basis of at least an amount of the minus overlap that is formed when the valve actuating device is placed in the predetermined case and a duration of the predetermined case.

3. The internal combustion engine according to claim 1, wherein
the controller performs at least one of increasing a fuel injection amount of the first injection valve and advancing an ignition timing of the first injection valve when the distribution ratio of the first fuel injection valve is set to 100%.

4. The internal combustion engine according to claim 3, wherein
the controller performs increasing the fuel injection of the first injection valve when a space in a catalyst interposed in an exhaust pipe which is in communication with the combustion chamber is in a reduction atmosphere, and performs advancing the ignition timing of the first injection valve when the space in the catalyst is an oxidation atmosphere.
